(19) United States
(12) Patent Application Publication
(10) Pub. No.: US 2017/0193593 A1
(43) Pub. Date: Jul. 6, 2017

(54) APPARATUS AND METHOD FOR PROVIDING SERVICE INFORMATION

(71) Applicant: SAMSUNG ELECTRONICS CO., LTD., Suwon-si (KR)

(72) Inventors: Inhak NA, Yongin-si (KR); Byungchul KIM, Suwon-si (KR); Sang-Jun MOON, Seoul (KR); Sin-Seok SEO, Seongnam-si (KR); Sanghyun CHANG, Seoul (KR); Daekyu CHOI, Suwon-si (KR)

(21) Appl. No.: 15/399,135

(22) Filed: Jan. 5, 2017

(30) Foreign Application Priority Data
Jan. 5, 2016 (KR) 10-2016-0000943

(51) Int. Cl. G06Q 30/06; H04W 4/02

(52) U.S. Cl. CPC G06Q 30/0639; H04W 4/023; H04W 4/025; H04W 4/005

(57) ABSTRACT

The present disclosure relates to a sensor network, Machine Type Communication (MTC), Machine-to-Machine (M2M) communication, and technology for Internet of Things (IoT). The present disclosure may be applied to intelligent services based on the above technologies, such as smart home, smart building, smart city, smart car, connected car, health care, digital education, smart retail, security and safety services. The present disclosure may be used for intelligent services (smart home, smart building, smart city, smart car or connected car, healthcare, digital education, retail, security and safety-related service, and the like) on the basis of the technology. The present disclosure provides an appropriate service by reflecting the location information of a user within a store in real or substantially real time. A method of operating a server device according to an example embodiment comprises: receiving at least one of distance information and direction information of the terminal device; determining a location of the terminal device using at least one of the distance information and the direction information; determining a target product based on the location of the terminal device; and transmitting service information related to the target product to the terminal device.

### CROSS-REFERENCE TO RELATED APPLICATION

This application is based on and claims priority under 35 U.S.C. §119 to Korean Application Serial No. 10-2016-0000943, which was filed in the Korean Intellectual Property Office on Jan. 5, 2016, the content of which is incorporated by reference herein in its entirety.

### TECHNICAL FIELD

The present disclosure relates generally to a scheme for providing service information in real time.

### BACKGROUND

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched.

Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications. In general, an off-line store is a less competitive marketplace than an on-line store. However, in the off-line store, a consumer may be provided with various real time services, such as coupons. Therefore, a showrooming situation may occur. Showrooming may refer to a situation in which a consumer visits the off-line store to check out information on a product but then purchases the product online.

### SUMMARY

An example embodiment of the present disclosure provides an apparatus and a method for providing a service to a user of a terminal device in a communication network.

Another example embodiment of the present disclosure provides an apparatus and method for providing service-related information to an electronic shelf label (ESL) device in a communication network.

Still another example embodiment of the present disclosure provides an apparatus and method for determining a target product (or product group) of a terminal device in a communication network.

Still another example embodiment of the present disclosure provides an apparatus and method for determining a location of a terminal device in a communication network.

Still another example embodiment of the present disclosure provides an apparatus and method for detecting a store entry of a terminal device in a communication network.

Still another example embodiment of the present disclosure provides an apparatus and method for determining movement path information of a terminal device in a communication network.

Still another example embodiment of the present disclosure provides an apparatus and method for determining a moving speed of a terminal device in a communication network.

Still another example embodiment of the present disclosure provides an apparatus and method for determining a moving direction of a terminal device in a communication network.

Still another example embodiment of the present disclosure provides an apparatus and method for determining a distance between a terminal device and a product in a communication network.

Still another example embodiment of the present disclosure provides an apparatus and method for determining at least one of a distance between a terminal device and a product and a moving direction of a terminal device in a communication network.

Still another example embodiment of the present disclosure provides an apparatus and method for determining a distance using the strength of a reception signal.

Still another example embodiment of the present disclosure provides an apparatus and method for measuring a direction using an incident angle of a reception signal.

According to an example embodiment of the present disclosure, a method of determining, by a server device, a product of interest, using a terminal device, comprises receiving at least one of distance information and direction information of a terminal device; determining a location of the terminal device using at least one of the distance information and the direction information; and determining a target product based on the location of the terminal device.

According to another example embodiment of the present disclosure, a method of operating a terminal device, comprises transmitting and/or receiving a signal to and/or from an Access Point (AP) device through a wireless communication connection; and receiving, from a server device, information related to a target product determined using the signal. The signal is used to determine the location of the terminal device, and the target product is determined based on the location of the terminal device.

According to another example embodiment of the present disclosure, a method of operating an Electronic Shelf Label (ESL) device, comprises receiving information related to a target product; and transmitting information related to the target product to a terminal device through an output unit. The target product is determined based on location information of the terminal.

According to another example embodiment of the present disclosure, a server device comprises a receiver configured to receive at least one of distance information and direction information of a terminal device; at least one processor configured to determine a location of the terminal device using at least one of the distance information and the direction information, and to determine a target product based on the location of the terminal device; and a transmitter configured to transmit service information related to the target product to the terminal.

According to another example embodiment of the present disclosure, a terminal device comprises at least one transceiver configured to transmit and/or receive a signal to and/or from an Access Point (AP) device through a wireless communication connection, and to receive, from a server device, information related to a target product determined using the signal. The signal is used to determine the location of the terminal device, and the target product is determined based on the location of the terminal device.

According to another example embodiment of the present disclosure, an Electronic Shelf Label (ESL) device, comprises at least one transceiver configured to receive information related to a target product, and to transmit information related to the target product to a terminal device through output circuitry of an output unit. The target product is determined based on location information of the terminal.

The present disclosure addresses the foregoing showrooming problem by determining a target product (or product group) and an available service based on location information of a terminal device, and by providing the same to a consumer in real time.

### BRIEF DESCRIPTION OF THE DRAWINGS

The above and other aspects, features, and attendant advantages of the present disclosure will be more apparent and readily understood from the following detailed description, taken in conjunction with the accompanying drawings, in which like reference numerals refer to like elements, and wherein:

FIG. 1 is a diagram illustrating an example network structure of an example service providing system based on location information of a terminal device according to the present disclosure;

FIG. 2 is a block diagram illustrating an example method for measuring a distance using the strength of a signal according to the present disclosure;

FIGS. 3A and 3B are diagrams illustrating example packet structures of a wireless signal according to the present disclosure;

FIG. 4 is a diagram illustrating an example method for measuring a direction using an angle of a reception signal according to the present disclosure;

FIG. 5 is a block diagram illustrating an example server device according to the present disclosure;

FIG. 6 is a flowchart illustrating an example operation performed by a server device according to the present disclosure;

FIG. 7 is a flowchart illustrating an example method for determining a target product and providing a service, by a server device, according to the present disclosure;

FIG. 8 is a flowchart illustrating an example method for determining a target product and providing a service, by a server device, according to the present disclosure;

FIG. 9 is a block diagram illustrating an example terminal device according to the present disclosure;

FIG. 10 is a flowchart illustrating an example method for receiving service-related information by a terminal device according to the present disclosure;

FIG. 11 is a flowchart illustrating an example method for receiving service-related information by a terminal device according to the present disclosure;

FIG. 12 is a signal flow diagram illustrating an example service based on location information of a terminal device according to the present disclosure;

FIG. 13 is a signal flow diagram illustrating an example embodiment in which an AP device determines a location of a terminal device 110 according to the present disclosure;

FIG. 14 is a signal flow diagram illustrating an example embodiment in which a terminal device determines at least one of a distance and a direction according to the present disclosure;

FIG. 15 is a flowchart illustrating an example method for providing service-related information through an ESL of a server device according to the present disclosure;

FIG. 16 is a block diagram illustrating an example ESL device according to the present disclosure;

FIG. 17 is a flowchart illustrating an example method for providing service-related information by an ESL device according to the present disclosure;

FIG. 18 is a signal flow illustrating an example service based on location information of a terminal device in a wired/wireless network structure including an ESL device according to the present disclosure;

FIG. 19 is a flowchart illustrating an example method for providing a service through the determination of a movement path of a terminal device, by a server device, according to the present disclosure;

FIGS. 20A and 20B are diagrams illustrating example movement path information of a terminal device and location information of a product according to the present disclosure; and

FIG. 21 is a flowchart illustrating an example method for operating a terminal device according to the present disclosure.

### DETAILED DESCRIPTION

The following description is made with reference to the accompanying drawings and is provided to assist in a comprehensive understanding of example embodiments of the disclosure as defined by the claims and their equivalents. It includes various specific details to assist in that understanding but these are to be regarded as merely examples. Accordingly, those of ordinary skill in the art will recognize that various changes and modifications of the example embodiments described herein can be made without departing from the scope and spirit of the disclosure. In addition, descriptions of well-known functions and constructions may be omitted for clarity and conciseness. Hereinafter, the present disclosure describes a technology for providing a service based on location information of a terminal in a wireless communication system.

Terms referring to control information, terms referring to network entities, terms referring to messages, terms referring to constituent elements of an apparatus, etc. used in the following descriptions are provided as examples for the convenience of description. Accordingly, the present disclosure is not limited to the following terms and other terms having the same technical meaning may be used.

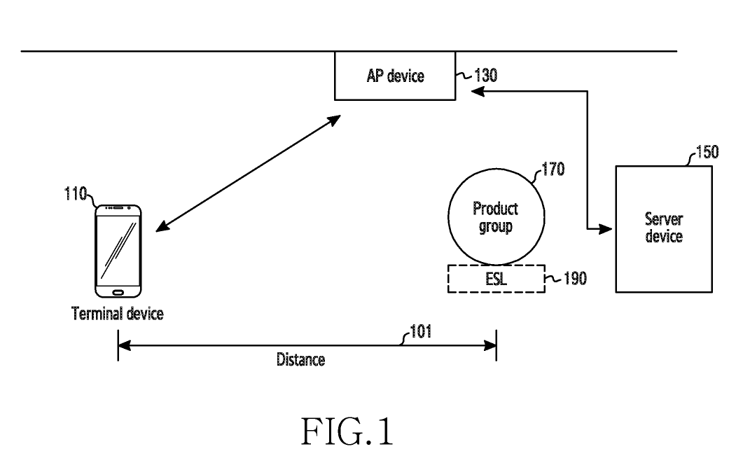

FIG. 1 is a diagram illustrating an example network structure of an example service providing system based on location information of a terminal device according to the present disclosure. A network structure of FIG. 1 may include a terminal device 110, an Access Point (AP) device 130, and a server device 150.

The terminal device 110 may refer, for example, to equipment used by a user. The terminal device 110 may be a device having a communication function included therein. For example, the terminal device may include at least one of a smart phone, a tablet personal computer (PCs), a mobile phone, a video phone, an e-book reader, a desktop PC, a laptop PC, a netbook computer, a personal digital assistant (PDA), a portable multimedia player (PMP), a MP3 player, a mobile medical apparatus, a camera, a wearable apparatus (e.g., head-mounted-apparatus (HMD) such as electronic glasses, electronic clothes, an electronic bracelet, an electronic necklace, an electronic accessory, an electronic tattoo, or a smart watch), or the like, but is not limited thereto.

In addition, depending on circumstances, the network structure in FIG. 1 may include an Electronic Shelf Label (ESL) device 190. The ESL device 190 may refer, for example, to a device for digitally displaying a product's name, price information, service information, and the like. For example, the ESL device 190 may refer to a device for digitally displaying the product's name, price, logo, and the like, using a low-power wireless communication technology and electronic paper display technology instead of displaying the same on paper using the existing method. The ESL device 190 may replace the price information, service information, and the like in real time, which are displayed in a large local store, such as big retailers. In addition, an off-line store operator may respond quickly to pricing, which is made by on-line distributors, using an ESL device, so that the issue of showrooming may be addressed. A product group 170 may be arranged within a store, and the server device 150 performs mapping of the location information of each product (or product group) and stores the same in a memory.

Although FIG. 1 illustrates one terminal device 110, a plurality of terminal devices may exist. In addition, although FIG. 1 illustrates one AP device 130, it may include a plurality of AP devices. Therefore, each of the plurality of terminal devices which have entered a store may perform wireless communication with a specific AP device. In addition, as each terminal device moves within the store, the terminal device may perform handover between the plurality of AP devices.

Referring to FIG. 1, the terminal device 110 has an application installed therein, which is managed by a store operator through the server device 150. A device identifier (device ID, MAC address) of the terminal device 110, personal information, and the like may be provided to the store operator during installation of the application the terminal device 110. The store operator may manage the device identifier and personal information corresponding thereto, through a server device.

When the terminal device 110 enters a store, the entrance of the terminal device 110 to the store may be detected by the terminal device 110. For example, the terminal device 110 may know the geographical location information of a store in advance (e.g., which is provided during the process of an application's installation), and may figure out the location where the terminal device is located through a Global Positioning System (GPS). Therefore, the terminal device 110 may detect that the terminal device has entered a store by comparing the geographical location information of the store and the location information of the terminal device itself. In another example, an application installed to the terminal device 110 may be operated as a background task. Accordingly, when the terminal device 110 enters the store, the terminal device 110 may detect, through an application, a signal transmitted from an AP device installed within a store, so as to detect the terminal device 110's entrance to the store.

The terminal device 110 which has entered the store may be connected to a specific AP device 130 (e.g., the closest AP device) through wireless communication. The terminal device 110 may transmit and receive a wireless signal to and from an AP device, and the terminal device 110 or AP device 130 may determine at least one of a distance and a direction between the terminal device 110 and the AP device 130, through the transmission and reception of the signal. In addition, at least one of the distance and direction may be periodically determined based on the movement of the terminal device 110. At least one of the determined distance information and direction information may be transmitted to the server device 150 through a wired or wireless communication network.

The server device 150 may determine the location of the terminal device 110 within a store using the distance and direction information. The server device 150 may receive, through an AP device, information required for determining the location of the terminal device 110. Information required for determining the location may include at least one of the distance information of the terminal device 110, the direction information of the terminal device 110, and the location information of the terminal device 110. For example, a server device, which has received at least one of relative distance information and direction information of the terminal device 110 from the specific AP device 130, may determine the location of the terminal device 110 within a store, using at least one of the location information of the specific AP device 130 and the received distance and direction information. The server device 150 may periodically receive at least one of the distance information and direction information and periodically determine the location information of the terminal device 110 using the same, and may accumulate and store the same in the memory. In another example, the server device 150 may directly receive the location information from the AP device 130. The server device 150 may periodically receive the location information from the AP device 130.

The server device 150 may determine the distance 101 between the terminal device 110 and the specific product group (or product) 170, using the (accumulated) location information of the terminal device 110 and the location information of the product. The server device 150 may determine a residence time during which the terminal device 110 stays at the store, using the accumulated location information of the terminal device 110. The server device 150 may determine the moving speed of the terminal device 110, using the accumulated location information. The server device 150 may determine the direction in which the terminal device 110 moves, using the accumulated location information.

The server device 150 may determine a product to be purchased (or product group), using at least one of the moving speed, residence time, moving direction of the terminal device 110, and information on the distance between a specific product and the terminal device. The product to be purchased (or product group to be purchased) refers to a product (or product group) that draws interest from a user of the terminal device 110 a product (or product group) that has a high possibility of being purchased by the user of the terminal device 110 when an additional service is provided. The product to be purchased (or product group to be purchased) may be referred to as a target product (or target product group).

The server device 150 may determine a service which can be provided to a target product (or product group) of the terminal device 110, and transmit information related to the determined service. The service-related information corresponds to characteristics, sales policy, or purchase promotion of the corresponding product. For example, an application or information which can be provided may include coupon information, additional discount information, interest-free purchase information, bonus free gift information and navigation information, etc. When the ESL device 190 is installed within a store, the server device 150 may transmit service information corresponding to the terminal device 110 to the ESL device 190. The ESL device 190 that has received service information may transfer the same to the user of the terminal device 110 through output circuitry of an output unit.

The server device 150 may determine, through a point of sales (POS) terminal, information on products purchased or not purchased by the user of the terminal device 110 among target products (or product group) of the terminal device 110. A store operator may install a POS terminal at a position in which sales account is performed and manage sales information and the like. The server device 150 may select a product that is not purchased by a user of the terminal device 110 among target products and provide a service for the same.

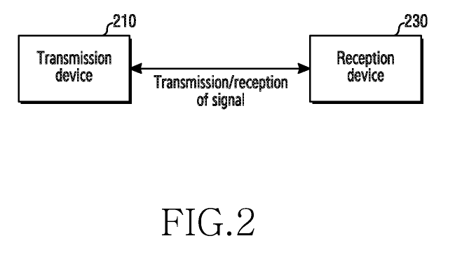

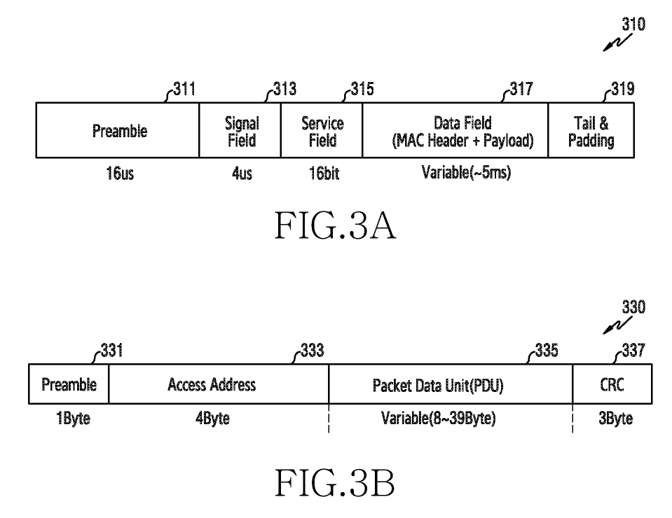

Before describing operation principles of various example embodiments, a principle of the measurement of the distance and direction using the strength and incident angle of transmission signal will be described with reference to FIGS. 2 and 3.

FIG. 2 is a block diagram illustrating an example method for measuring a distance using the strength of a signal according to the present disclosure. Referring to FIG. 2, the transmission device 210 may be the terminal device 110 of FIG. 1, and the reception device 230 may be the AP device 130 of FIG. 1 according to an example embodiment. The transmission device 210 may be the AP device 130 of FIG. 1 and the reception device 230 may be the terminal device 110 of FIG. 1 according to another example embodiment.

Referring to FIG. 2, the transmission device 210 may transmit a wireless signal to the reception device 230 using a wireless communication method. The wireless communication method may include, for example, and without limitation, Near Field Communication (NFC), ZigBee, WI-FI, Bluetooth Low Energy (BLE), and a beacon communication method. The reception device 230 may receive a wireless signal and measure the distance using the Received Signal Strength Indicator (RSSI). The RSSI may refer, for example, to an indicator indicating the strength of a reception signal. In an ideal environment where noise does not exist, RSSI values at the same location for the same wireless signal are always the same. As a unit of RSSI, dBm may be used, and as the figure becomes larger, the reception signal strength becomes stronger. Since the RSSI is inversely proportional to the square of distance, the further the distance, the weaker the signal strength. The reception device 230 may measure the distance between the transmission device 210 and the reception device 230, using the characteristics of RSSI described above.

A wireless signal that is transmitted or received between the transmission device 210 and the reception device 230 in FIG. 2 may be a beacon signal according to an example embodiment. The transmission device 210 may transmit a beacon signal through WI-FI Direct, an infrared ray (IR), a Bluetooth, and the like, but is not limited thereto. The transmission device 210 may broadcast fixed information included in a packet to the reception device 230. The fixed information may include various pieces of information. For example, the beacon signal may include an identifier of the transmission device 210. In addition, the beacon signal may include schematic information on the product. For example, the beacon signal may include identification information on the product. In addition, the transmission device 210 may periodically transmit a beacon signal to the reception device 230. For example, the period during which the transmission device 210 transmits a signal to the reception device 230 (or multiple reception devices) may be 200 ms to 300 ms. However, transmission periods of 200 ms to 300 ms are simply examples, and the transmission device 210 may transmit a signal at a period predetermined by a user or at a different transmission period depending on purposes. The reception device 230 receives a beacon signal periodically transmitted by the transmission device 210 during which the reception device exists at an effective distance from the transmission device 210. For example, the reception device 230 may receive a signal from the transmitting device 210 when the reception device is located within the coverage of the transmission device 210.

The reception device 230 may not require a pairing for receiving a beacon signal, which is transmitted by the transmission device 210. A pairing may refer, for example, to a procedure of registering a counterpart device in order to perform a wireless communication connection, such as Bluetooth and the like. For example, if a separate pairing is required when the reception device 230 receives a beacon signal transmitted by the transmission device 230, the reception device 230 has to register a unique identifier capable of identifying the transmission device 210 in the reception device 230, and the reception device 230 may receive only the beacon signal transmitted by the transmission device 210 corresponding to the registered identifier. Since the reception device 230 does not require a separate paring when receiving a beacon signal transmitted by the transmission device 210, the reception device 230 may receive a beacon signal transmitted by an arbitrary transmission device 210.

The transmission device 210 may transmit the beacon signal to the reception device 230 in a predetermined signal strength. In other words, the reception device 230 may receive the beacon signal from the transmission device 210 if the reception device is located within the effective range of the beacon signal. For example, the effective range of the beacon signal may be 50 m. In this case, the reception device 230 may receive a beacon signal when the reception device is located within 50 m from the transmission device 210.

FIGS. 3A and 3B are diagrams illustrating example packet structures of a wireless signal according to the present disclosure. FIG. 3A and FIG. 3B show a packet structure of a Wi-Fi signal and a BLE beacon signal, respectively. The transmission device 210 may transmit a signal of FIG. 3A or FIG. 3B, as an example, which is not limited to an embodiment. Therefore, it is apparent that not only the wireless signal of FIGS. 3A and 3B, but also different kinds of wireless signal may be used for the purpose of the present disclosure.

Referring to FIG. 3A, a Wi-Fi packet 310 complying to the Institute of Electrical and Electronics Engineers (IEEE) 802.11 standard may include a preamble 311, a signal field 313, a service field 315, a data field 317, and a tail and padding 319. Although FIG. 3A illustrates only the above elements, various modifications are performed depending on circumstances. In addition, in FIG. 3A, the magnitude (e.g., preamble 16, signal field 4, etc.) of each element is illustrated as an example, and may be changed according to another embodiment.

The preamble 311 is used for stably transmitting and receiving the Wi-Fi signal 310. For example, the reception device 230 may perform a frequency synchronization, symbol timing estimation, and automatic gain control of the beacon signal 310 transmitted from the transmission device 210 using the preamble 311. The reception device 230 may adjust the gain and phase of a phased array antenna to match to the direction of a packet received using the preamble 311. The signal field 313 includes information related to the modulating scheme of a wireless signal. The reception device 230 may demodulate a reception signal using information related to the modulating scheme of the signal field 313. The service field 315 may include information related to the transmitting frequency, symbol clock, and the like of a wireless signal. The data field 317 may include information for synchronizing a descrambler in the reception device 230. The data field 317 may include various pieces of information according to the present disclosure. For example, the data field 317 may include distance information, direction information, location information of a terminal device, service information provided to the terminal device, and the like. The tail and padding 319 may be generated by replacing an end bit of the Wi-Fi signal with non-scrambled zero bits.

Referring to FIG. 3B, a BLE beacon packet 330 may include a preamble 331, an access address 333, a Packet Data Unit header (PDU) 335, and a Cyclic Redundancy Check (CRC) 337. For convenience of explanation, FIG. 3B illustrates only the above elements, but in some cases, various modifications can be made depending on circumstance. In addition, in FIG. 3B, the size of each configuration (e.g., 1 byte of preamble, 4 bytes of access-address, etc.) is illustrated as an example and may be changed according to another example embodiment.

The preamble 331 is used for the BLE beacon signal 330 to be stably transmitted and received. For example, the reception device 230 may perform a frequency synchronization, symbol timing estimation, and automatic gain control of the beacon signal 330 transmitted from the transmission device 210 using the preamble 331. The reception device 230 may adjust the gain and phase of a phased array antenna to match to the direction of a packet received using the preamble 331. The access address 333 is a field for identifying the beacon signal on a physical layer channel. For example, the reception device 230 may identify whether a signal that is currently transmitted by using the access address 333 is a signal transmitted from an advertising channel or a signal transmitted from a data physical channel. The advertising channel is a channel for advertising a packet on the channel so as to connect two or more devices. The data physical channel is a channel for communication between two or more devices being connected to each other. The PDU 335 may include a PDU header and a PDU payload. The PDU header may include information related to logical transport, logical link identifiers, and the like. For example, the PDU header may include information of a PDU payload (e.g., the length of a PDU payload). The PDU payload may include information on a logical link control and adaptation protocol (L2CAP) signal, L2CAP frames, or user data. For example, the PDU payload may include product information or information for differentiating the transmission device 210 from other transmission devices. The CRC 337 may include information related to data transmission error detection.

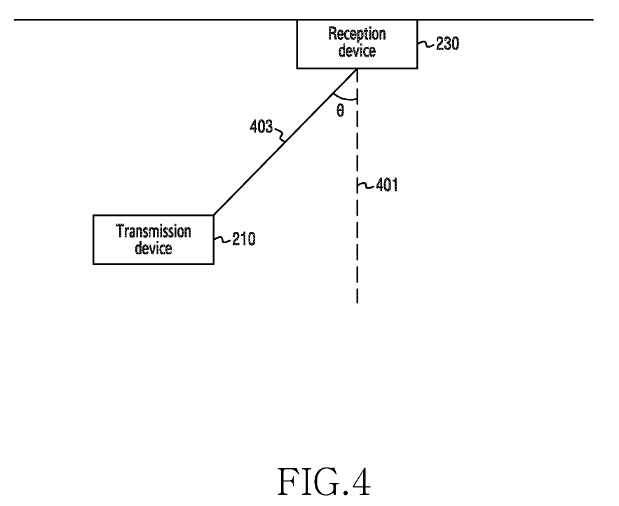

FIG. 4 is a diagram illustrating an example method for measuring a direction using an angle of a reception signal according to the present disclosure. Referring to FIG. 4, the transmission device 210 may be the terminal device 110 of FIG. 1, and the reception device 230 may be the AP device 130 of FIG. 1 according to an example embodiment. The transmission device 210 may be the AP device 130 of FIG. 1, and the reception device 230 may be the terminal device 110 of FIG. 1 according to another example embodiment.

Referring to FIG. 4, the transmission device 210 may transmit a wireless signal to the reception device 230 using a wireless communication method. The reception device 230 may receive a wireless signal, and determine the direction of the transmission device using an angle of arrival (AOA) of the reception signal. For example, the reception device 230 may use a plurality of antennas, and may measure an angle of a reception signal based on a phase value of a reception signal for each antenna. In another example, the angle of a reception signal may be estimated based on the direction of a beam applied to a beamforming signal performed between the reception device 230 and the transmission device 210. For example, the reception device 230 may recognize and determine the propagation direction of a wireless signal transmitted from the transmission device 210. For example, referring to FIG. 4, the reception device 230 may arbitrarily set an imaginary line 401. In addition, the reception device 230 may determine an angle θ between a reception signal 403 and an imaginary line 401. The reception device 230 may determine the direction of the transmission device 210 based on the reception device 230, using the determined angle θ.

The reception device 230 may determine the location of the transmission device 210 using a distance determination method using RSSI, which is illustrated in FIG. 2, and a direction measurement method using AOA, which is illustrated in FIG. 4. For example, it may be considered that the reception device 230 is generally fixed and the transmission device 210 is generally a movable means. In this case, the reception device 230 may previously know the fixed coordinates of the reception itself through a user's input or GPS. The reception device 230 may determine the location of the transmission device 210 based on at least one of the determined distance information and direction information of the transmission device 210 based on the coordinates of the reception device itself.

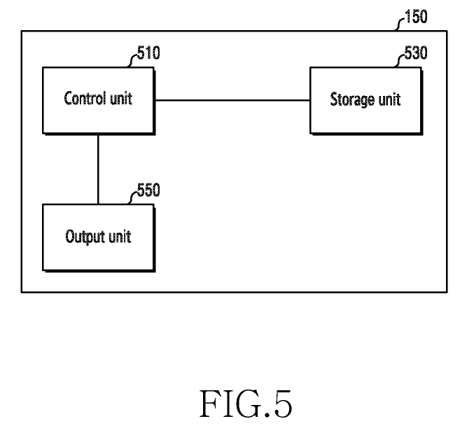

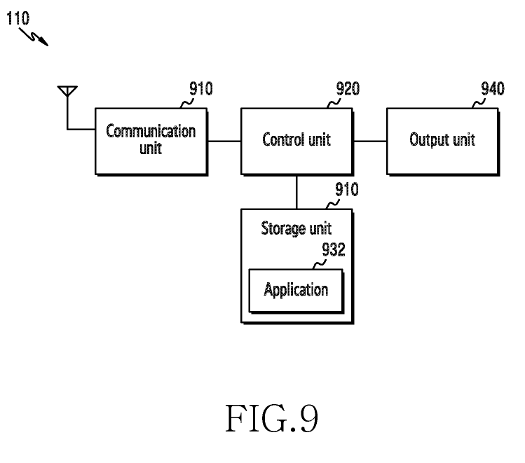

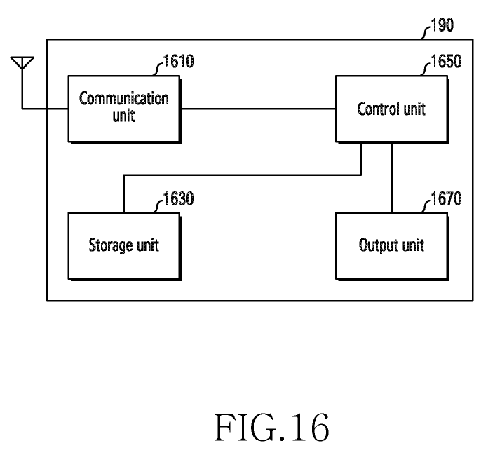

FIG. 5, FIG. 9 and FIG. 16 are block diagrams illustrating example respective devices according to the present disclosure. Terms such as ‘ unit’ and ‘ device’ used hereinafter refer to units for processing at least one function or operation, which may be implemented by hardware, software, or a combination of hardware and software.

FIG. 5 is a block diagram illustrating an example server device according to the present disclosure. A server device of FIG. 5 may refer, for example, to a server device 150 of FIG. 1. Referring to FIG. 5, the server device 150 may include a control unit (e.g., including processing circuitry) 510 and a storage unit 530. In addition, the server device 150 may include an output unit (e.g., including output circuitry) 550 for providing information to a server manager. However, since the output unit 550 is not an essential configuration of the server device 150, so it may be omitted according to another example embodiment. The server device 150 may further include an interface for wired or wireless communication with the AP device 130 although it may not be shown in drawings.

The control unit 510 may include various processing circuitry that controls overall operations of the server device 150. For example, the control unit 510 controls transmission and reception of a signal through wired communication. In addition, the control unit 510 records and reads data in and from the storage unit 530. To this end, the control unit 510 may include various processing circuitry, such as, for example, and without limitation, at least one processor or a microprocessor, or may be part of a processor. For example, the control unit 510 may perform control such that the server device 150 determines the location of the terminal device 110 and the distance between the product group 170 and the terminal device 110 according to various example embodiments described hereinafter. The control unit 510 may determine a residence time of the terminal device 110. The control unit 510 may determine a target product based on the determined information and determine a service to be provided to the terminal device 110.

The storage unit 530 stores data, such as a basic program, an application program, and setting information, and the like for the operation of the server device 150. The storage unit 530 may be configured as a volatile memory, a non-volatile memory, or a combination of a volatile memory and a non-volatile memory. In particular, the storage unit 530 may store customer information (device ID, age, sex, etc.), customer's movement path information, customer's location information, and product's location information according to the present disclosure. In addition, the storage unit 530 provides the stored data according to a request of the control unit 510. The output unit 550 may include a display device, a speaker device, and the like, and may also provide sound and image information to the server manager.

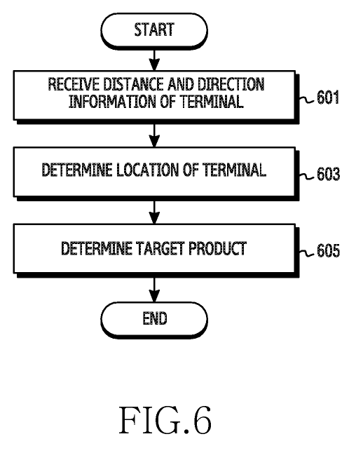

FIG. 6 is a flowchart illustrating an example operation performed by a server device according to the present disclosure. The server device 150 may refer, for example, to computer hardware in which the server program is executed. The server device 150 provides a service of an intensive processing function in a Local Area Network (LAN). The server device 150 may be operated and managed by an individual business operator who is an entity for selling a product or providing a service. An example operation method of the server device 150 may be as follows.

The server device 150 may receive at least one of the distance information and direction information of the terminal device 110 from the specific AP device 130 according to an embodiment in step 601. The server device 150 may periodically receive and accumulate (e.g., store in the memory) at least one of the distance information and direction information of the terminal device 110 over time.

The server device 150 may determine the location of the terminal device 110 in step 603. For example, the server device 150 may determine the location of the terminal device 110 based on at least one of the distance information and direction information of the terminal device 110, which are received from the specific AP device 130. According to an example embodiment, the location of the terminal device 110 may be a relative location based on geographical information of a store. According to an example embodiment, the location of the terminal device 110 may be an absolute location based, for example, on GPS.

The server device 150 may determine a specific product (or product group) as a product to be purchased (or a target product group) in step 605. The product to be purchased may be referred to as a target product. The server device 150 may determine whether the terminal device 110 becomes close to a specific product. For example, the server device 150 may load the location information of a product, which is stored in the memory of the server device 150. The server device 150 may compare the location information of a product with the location information of the terminal device 110, and determine the distance between the terminal device 110 and the specific product (or product group). The server device 150 may determine whether the terminal device becomes close to the specific product, based on at least one of the distance between the terminal device 110 and the specific product (or product group) 170, a residence time during which the terminal device 110 stays in the vicinity of a specific product (or product group), the moving direction of the terminal device 110 toward a specific product (or product group), and the moving speed of the terminal device 110 in which the terminal device 110 moves in the vicinity of the specific product (or product group). When it is determined that the specific product becomes close to the terminal device 110, the server device 150 may determine the specific product as the target product.

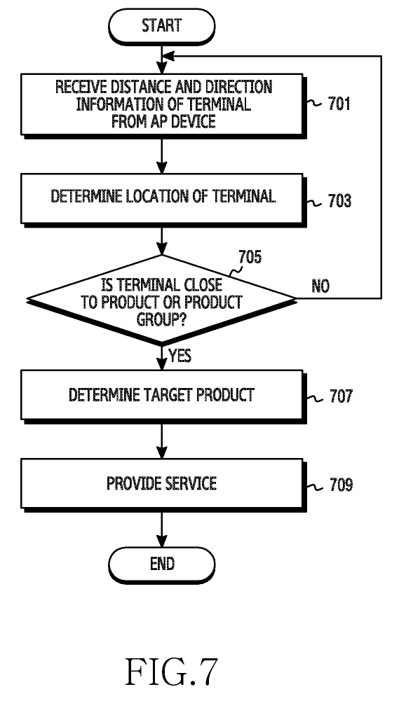

FIG. 7 is a flowchart illustrating an example method for determining a target product and providing a service, by a server device, according to the pre sent disclosure.

The server device 150 may receive at least one of the distance information and the direction information of the terminal device 110 from the specific AP device 130 according to an example embodiment in step 701. The server device 150 may periodically receive and accumulate (i.e., store in the memory) at least one of the distance information and direction information of the terminal device 110 over time. For example, the specific AP device 130 may include an AP device for transmitting and receiving a signal to and from the current terminal device, and a target AP device may be changed (i.e., handover between AP devices) according to the movement of the terminal device 110. Although not shown in the drawing, the server device may include an interface for wired communication with the specific AP device 130 and receive information from the specific AP device 130 through the wired interface. An interface for communication may be referred to as a communication unit. The communication unit may be referred to as a transmission unit and a reception unit. According to an example embodiment, the specific AP device 130 may determine at least one of the distance and direction between the specific AP device 130 and the terminal device 110, using strength (e.g., RSSI) and an incident angle (e.g., AOA) of a signal transmitted from the terminal device 110. A specific method for determining at least one of the distance and direction has been described with reference to FIG. 2 and FIG. 4. The server device 150 may receive the distance information and direction information of the terminal device 110, determined by the specific AP device 130, through a wired communication interface.

The server device 150 may determine a location of the terminal device 110 in step 703. For example, the server device 150 may determine the location of the terminal device 110 based on at least one of the distance information and direction information of the terminal device 110, received from the specific AP device 130. An operator may store, in the memory of the server device 150, the geographical information of a store, location information of a product and product group, and location information of AP devices (including a specific AP device), and operate and manage the same. For example, when a plurality of AP devices exist within a store, the operator may store the location information of each AP device in the server device 150 and operate and manage the same. According to an example embodiment, the location of the terminal device 110 may be a relative location based on the geographical information of the store. According to an example embodiment, the location of the terminal device 110 may be an absolute location based on GPS. The server device 150 may determine the location of the terminal device 110 based on at least one of the distance information and direction information of the terminal device 110, received from the specific AP device 130. The server device 150 may determine the location of the terminal device 110 using a plurality of AP devices installed in the vicinity of the terminal device 110. For example, the server device 150 may receive the distance information of the terminal device 110 from AP devices, located in the vicinity of the terminal device 110, and may determine the location of the terminal device 110 through the triangulation method.

The server device 150 may determine whether the terminal device 110 becomes close, e.g., within a predetermined proximity or threshold distance, to a specific product in step 705. For example, the server device 150 may load the location information of a product, which is stored in the memory of the server device 150. The location information of the product may include location information of a specific product group (e.g., a beverage product group, a kitchenware product group, a cleaning tool group, a tea product group, etc.), the location information of a product group specified by a store operator, and the location information of a product group arbitrarily designated by the terminal device 110 (e.g., a product group designated by a customer in advance). The location information of the product may include individual location information of each product. The server device 150 may compare the location information of a product and the location information of the terminal device 110, and determine the distance between the terminal device 110 and the specific product (or product group). Table 1 illustrates an example of the determined distance between a product and a terminal as an example.

TABLE 1

| | Product | Terminal | Distance |
|---|---|---|---|
| Product | location (A) | location (B) | (A-B) |
| Fruit | (34, 8) | (30, 6) | 0.8 |
| Vegetable | (47, 8) | (45, 7) | 0.3 |
| Grain | (44, 16) | (42, 18) | 0.5 |
| Kitchen appliance | (35, 27) | (30, 24) | 0.7 |

According to an embodiment, in order to determine whether the terminal device 100 is close to a particular product, when the distance between the terminal device 110 and a specific product (or product group) is smaller than the threshold value α, the server device 150 may determine that the terminal device 110 is close to the specific product (or product group). According to another example embodiment, in order to determine whether the terminal device 100 is close to a particular product, the server device 150 may determine the residence time during which the terminal device 110 stays in the vicinity of a specific product (or product group) based on the change in the location information of the terminal device 110. The server device 150 may determine that the terminal device 110 is close to a specific product (or product group) when the residence time during which the terminal device 110 stays in the vicinity of a specific product (or product group) is larger than the threshold value β. According to still another embodiment, in order to determine whether the terminal device 110 is close to a particular product, the server device 150 may determine the moving speed of the terminal device 110 based on the change in the location information of the terminal device 110. The server device 150 may determine that the terminal device 110 becomes close to a specific product (or product group) when the moving speed in the vicinity of a specific product (or product group) is smaller than the threshold value γ. According to still another example embodiment, in order to determine whether the terminal device 110 is close to a particular product, the server device 150 may determine a moving direction of the terminal device 110 based on the change in the location information of the terminal device 110. The server device 150 may determine that the terminal device 110 becomes close to a specific product (or product group) when the moving direction in which the terminal device 110 is directed to a specific product with an angle less than a threshold value δ.

As a result, the server device 150 may determine whether the terminal device becomes close to the specific product, based on at least one of the distance between the terminal device 110 and the specific product (or product group), residence time during which the terminal device stays in the vicinity of a specific product (or product group), the moving direction of the terminal device 110 with respect to a specific product (or product group), and the moving speed of the terminal device 110 in which the terminal device 110 moves the vicinity of the specific product (or product group).

According to an example embodiment, when it is determined that terminal device 110 is not close to a specific product (or product group), the server device 150 may receive, from a specific AP device 130 (or another AP device due to handover between AP devices), at least one of the distance information and direction information of the terminal device 110, which is changed according to the movement of the terminal device 110, and repeatedly perform step 701 to step 705.

According to another example embodiment, when it is determined that terminal device 110 becomes close to a specific product (or product group), the server device 150 may determine the specific product (or product group) as a product to be purchased (or product group to be purchased) in step 707. The product to be purchased may be referred to as a target product. The server device 150 may match the determined target product (or target product group) information to a device identifier (device ID, MAC address) of the terminal device 110, and store the same in the memory of the server device 150.

The server device 150 may provide a service to the terminal device 110 in step 709. For example, the server device 150 may determine a service to be provided to the terminal device 110 based on information on the determined target product (or product group), and transmit the service-related information to the terminal device 110. The service-related information may include, for example, coupon information related to a target product (or product group), additional discount information, interest-free purchase benefit information, bonus free gift information, and navigation information, and the like. When an ESL device 190 is installed within a store, the server device 150 may transmit service-related information to the ESL device 190, and the ESL device 190 may display the service-related information through an output unit.

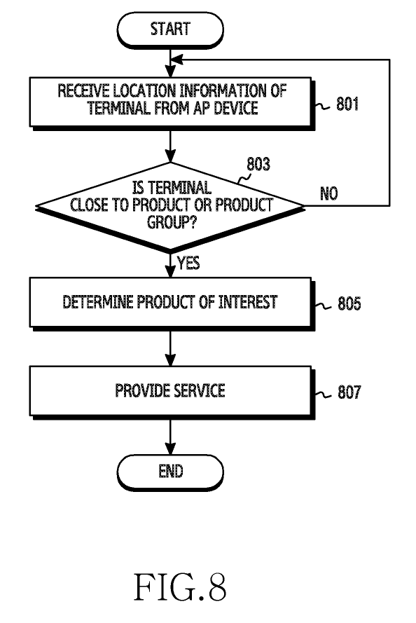

FIG. 8 is a flowchart illustrating an example method for determining a target product and providing a service, by a server device, according to the present disclosure. The server device 150 may refer, for example, to computer hardware in which the server program is executed. An example operation method of the server device 150 may be as follows.

The server device 150 may receive location information of the terminal device 110 from the specific AP device 130 according to an embodiment in step 801. The server device 150 may periodically receive and accumulate (i.e., store in the memory) location information of the terminal device 110 over time. For example, the specific AP device 130 includes an AP device for transmitting and receiving a signal to and from the current terminal device, and a target AP device may be changed (e.g., handover between AP devices) according to the movement of the terminal device 110. According to an example embodiment, the specific AP device 130 may determine at least one of the distance and direction between the specific AP device 130 and the terminal device 110, using the strength (e.g., RSSI) and the incident angle (e.g., AOA) of a signal transmitted from the terminal device 110. An example method for determining at least one of the distance and direction has been described with reference to FIG. 2 and FIG. 4. The specific AP device 130 may determine the location of the terminal device 110 based on at least one of the distance information and direction information of the terminal device 110. The specific AP device 130 may determine the location of the terminal device 110 based on at least one of the distance information and direction information of the terminal device 110. The server device may periodically receive location information of the terminal device 110 from the specific AP device 130.

The server device 150 may determine whether the terminal device 110 becomes close to a specific product in step 803. For example, the server device 150 may load the location information of a product (or product group), which is stored in the memory of the server device 150. According to an embodiment, in order to determine whether the terminal device 100 becomes close to a specific product, when the distance between the terminal device 110 and the specific product (or product group) is less than the threshold value α, the server device 150 may determine that the terminal device 110 is close to the particular product (or product group). The server device 150 may determine that the terminal device 110 is close to a specific product (or product group) when the residence time during which the terminal device 110 stays in the vicinity of a specific product (or product group) is larger than the threshold value β. The server device 150 may determine that the terminal device 110 is close to a specific product (or product group) when the moving speed in which the terminal device 110 moves in the vicinity of a specific product (or product group) is less than the threshold value γ. The server device 150 may determine that the terminal device 110 is close to a specific product (or product group) when the moving direction in which the terminal device 110 is directed to a specific product with an angle less than a threshold value δ.

As a result, the server device 150 may determine whether the terminal device is close to the specific product, based on at least one of the distance between the terminal device 110 and the specific product (or product group), the residence time during which the terminal device stays in the vicinity of a specific product (or product group), the moving direction of the terminal device 110 with respect to a specific product (or product group), and the moving speed of the terminal device 110 in which the terminal device moves in the vicinity of the specific product (or product group).

According to an example embodiment, when it is determined that terminal device 110 is not close to a specific product (or product group), the server device 150 may receive, from a specific AP device 130 (or another AP device due to handover between AP devices), at least one of the distance information and direction information of the terminal device 110, which is changed according to the movement of the terminal device 110, and repeatedly perform step 801 to step 803.

According to another example embodiment, when it is determined that terminal device 110 is close to a specific product (or product group), the server device 150 may determine the specific product (or product group) as a product to be purchased (or product group to be purchased) in step 805. The product to be purchased may be referred to as a target product. The server device 150 may match the determined target product (or target product group) information to a device identifier (device ID, MAC address) of the terminal device 110, and store the same in the memory of the server device 150.

The server device 150 may provide a service to the terminal device 110 in step 807. For example, the server device 150 may determine a service to be provided to the terminal device 110 based on the determined target product (or product group) information, and transmit the service-related information to the terminal device 110. The service-related information may include coupon information related to a target product (or product group), additional discount information, interest-free purchase benefit information, bonus free gift information, and navigation information, and the like. When an ESL device 190 is installed within a store, the server device 150 may transmit service-related information to the ESL device 190, and the ESL device 190 may display the service-related information through an output unit.

FIG. 9 is a block diagram illustrating an example terminal device according to the present disclosure. A terminal device of FIG. 9 corresponds to the terminal device 110 of FIG. 1. Referring to FIG. 9, the terminal device 110 includes a communication unit (e.g., including communication circuitry) 910, a control unit (e.g., including a controller and/or processing circuitry) 920, and a storage unit 930. In addition, the terminal device 110 may further include an output unit (e.g., including output circuitry) 940 for displaying various pieces of information.

The communication unit 910 may include various communication circuitry configured to perform functions for transmitting and receiving signals through a wireless channel. For example, the communication unit 910 may perform a conversion function between a baseband signal and a bit string according to the physical layer specification of the system. For example, during data transmission, the communication unit 910 may generate complex symbols by encoding and modulating transmission bit strings. In addition, upon receiving the data, the communication unit 910 may reconstruct reception bit strings by demodulating and decoding the baseband signal. In addition, the communication unit 910 may up-convert the baseband signal into a radio frequency (RF) band signal and then transmits the converted signal through the antenna, and down-converts an RF band signal received through the antenna into the baseband signal. For example, the communication unit 910 may include various communication circuitry, such as, for example, and without limitation, a transmission filter, a reception filter, an amplifier, a mixer, an oscillator, a Digital to Analog Convertor (DAC), an Analog to Digital Convertor (ADC), or the like.

In addition, the communication unit 910 may include a plurality of RF chains. Further, the communication unit 910 may perform beamforming. For beamforming, the communication unit 910 may adjust the phase and the magnitude of each of signals transmitted and received through a plurality of antennas or antenna elements. Further, the communication unit 910 may include a plurality of communication modules to support a plurality of different wireless connection technologies.

In addition, the communication unit 910 may include different communication modules for processing signals of different frequency bands. For example, different communication standards may include Bluetooth low energy (BLE), Wi-Fi, Wi-Fi Gigabyte (WiGig), cellular networks (e.g., Long Term Evolution (LTE), and the like. In addition, different frequency bands may include a super high frequency (SHF) (e.g., 2.5 GHz, 5 GHz) band and a millimeter wave (e.g., 60 GHz) band.

The communication unit 910 may include various circuitry that transmits and receives signals as described above. Accordingly, the communication unit 910 may be referred to as a transmission unit, a reception unit, or a transceiver or transceiver unit. In addition, the transmission and reception performed through the wireless channel in the description of the present disclosure are used for meaning that the processing as described above is performed by the communication unit 910.

The control unit 920 may include various processing and/or control circuitry configured to control overall operations of the terminal device 110. For example, the control unit 920 may control transmission and reception of a signal through the communication unit 910. In addition, the control unit 920 may record and read data in and from the storage unit 930. To this end, the control unit 920 may include various circuitry, such as, for example, and without limitation, at least one processor, dedicated processor or a microprocessor, or may be part of a processor. In addition, a part of the communication unit 910 and the control unit 920 may be referred to as a Communication Processor (CP). For example, according to various example embodiments described hereinafter, the control unit 920 may perform control such that a terminal device receives a signal from the AP device 130 and determine at least one of the distance and direction of the terminal device based on the information included in the received signal. In addition, the control unit 920 may control the terminal device 110 to transmit at least one of the determined distance information and direction information through the communication unit 910. In addition, the control unit 920 may perform control such that the terminal device 110 receives the service-related information transmitted from the server through the communication unit 910. The control unit 920 may control such that the terminal device 110 displays the service-related information received from the server through the output unit 940.

The storage unit 930 stores data such as a basic program, an application program, and setting information, and the like for the operation of the terminal device 110. The storage unit 930 may be configured as a volatile memory, a non-volatile memory, or a combination of a volatile memory and a non-volatile memory. For example, the storage unit 930 may store service-related information obtained from the server in accordance with the present disclosure. The storage unit 930 may store an application 932 required to receive a service from the server device 150 (or a store manager). The storage unit 930 may store the distance and direction information determined through the control unit 920. In addition, the storage unit 930 provides the stored data according to a request of the control unit 920.

The output unit 940 may include various output circuitry configured to output service-related information provided from the server device according to the present disclosure. The output unit 940 may include various output circuitry, such as, for example, and without limitation, at least one of a speaker device, a display device, a vibration device, and a hologram device. The display device may include a Liquid Crystal Display (LCD), a Light-Emitting Diode (LED) display, an Organic Light-Emitting Diode (OLED) display, a Micro Electro Mechanical Systems (MEMS) display, or an electronic paper display, or the like, but is not limited thereto. The output unit 940 may display, for example, various types of contents (e.g., text, images, videos, icons, or symbols) to users. The output unit 940 may include a touch screen, and may receive a touch, gesture, proximity, or hovering input using, for example, an electronic pen or the user's body part. The output unit 940 may output service-related information, received from the server device, as sound or image information.

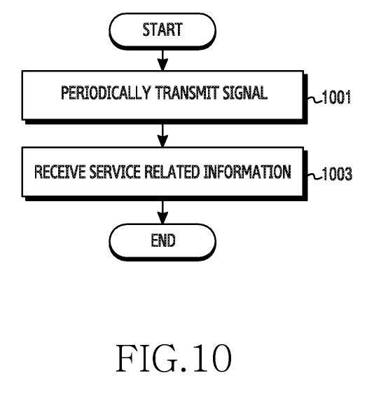

FIG. 10 is a flowchart illustrating an example method for receiving service-related information by a terminal device according to the present disclosure. A terminal device of FIG. 10 corresponds to the terminal device 110 of FIG. 1.

The terminal device 110 may periodically transmit a signal in step 1001. For example, the terminal device 110 may be wirelessly connected to the specific AP device 130 (adjacent AP device) when entering a store. The terminal device 110, wirelessly connected to the specific AP device 130, may periodically transmit a wireless signal to the specific AP device 130. According to an example embodiment, the terminal device 110 may move within a store, and in this case, the terminal device 110 may be wirelessly connected to another AP device. For example, as the terminal device 110 moves in the store, the terminal device 110 may perform handover between a plurality of AP devices installed within the store. In this case, the terminal device 110 may periodically transmit a wireless signal to an AP device that is currently being connected through wireless communication. The AP device that is currently being connected to the terminal device 110 through wireless communication may periodically receive the wireless signal from the terminal device 110.

The terminal device 110 may receive service-related information from the server device 150 in step 1003. The server device 150 may determine a target product (or product group) based on location information of the terminal device 110. According to an example embodiment, the server device 150 may periodically receive the location information of the terminal device 110 from the AP device 130, and may accumulate and store the periodically received location information of the terminal device 110 in the memory. According to another example embodiment, the server device 150 may receive at least one of the distance information and direction information of the terminal device 110 from the AP device 130, and determine the location of the terminal device 110 using at least one of the distance information and direction information. The server device 150 may periodically determine the location of the terminal device 110 using at least one of the distance information and direction information, periodically received from the AP device 130, and store the same in the memory. The server device 150 may determine at least one of the distance between the terminal device 110 and a specific product (or product group), the residence time during which the terminal device 110 stays in the vicinity of a specific product (or product group), the moving speed in which the terminal device 110 moves in the vicinity of a specific product (or product group), and the moving direction in which the terminal device 110 moves the vicinity of a specific product (or product group), based on the (accumulated) location information of the terminal device 110, received from the AP device 130 or determined by the server device 150.

The server device 150 may determine a target product based on at least one of the distance, the residence time, the moving speed, and the moving direction. The server device 150 may determine a service to be provided to the terminal device 110 based on the determined target product (or product group) information, and transmit the service-related information to the terminal device 110. The service-related information may include coupon information related to a target product (or product group), additional discount information, interest-free purchase benefit information, bonus free gift information, and navigation information, and the like. The terminal device 110 may receive service-related information from the server device 150. Although not shown in drawings, the terminal device 110 may include an output unit, and the terminal device 110 may indicate service-related information, received from the server device 150, through an output unit.

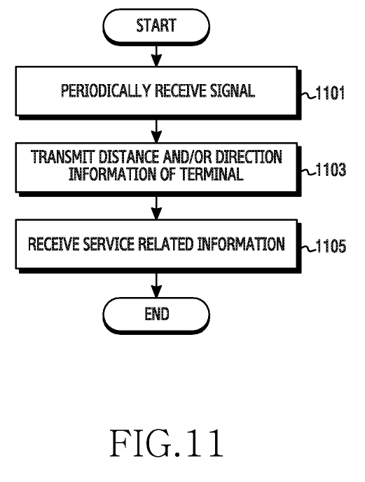

FIG. 11 is a flowchart illustrating an example method for receiving, by a terminal device, service-related information according to the present disclosure. A terminal device, which performs operations illustrated in the steps of FIG. 11, corresponds to the terminal device 110 of FIG. 1.

The terminal device 110 may periodically receive a signal in step 1101. For example, the terminal device 110 may be wirelessly connected to the specific AP device 130 (adjacent AP device) when entering a store. The terminal device 110, which is wirelessly connected to the specific AP device 130, may periodically receive a wireless signal from the specific AP device 130. According to an example embodiment, the terminal device 110 may move within a store, and in this case, the terminal device 110 may be wirelessly connected to another AP device. For example, as the terminal device 110 moves in the store, the terminal device 110 may perform handover between a plurality of AP devices installed within the store. In this case, the terminal device 110 may periodically receive a wireless signal from an AP device that is currently being connected through wireless communication. The AP device that is currently being connected to the terminal device 110 through wireless communication may periodically transmit a wireless signal to the terminal device 110.

The terminal device 110 may transmit at least one of the distance information and direction information of the terminal device 110 in step 1103. For example, the terminal device 110 may determine the distance between the terminal device 110 and the AP device 130 that is being connected through wireless communication, and may further determine the direction of the terminal device 110, using a signal received from the AP device 130. For example, the terminal device 110 may determine, using RSSI and AOA, the distance between the terminal device 110 and the AP device 130, and the relative direction between the terminal device 110 and the AP device 130, respectively. The terminal device 110 may transmit at least one of the determined distance information and direction information to the AP device 130 that is being currently connected through wireless communication or the server device 150 through the AP device 130. The terminal device 110 may periodically determine at least one of the distance and direction, and periodically transmit the same to the AP device 130 or the server device 150 through the AP device 130.

The terminal device 110 may receive service-related information from the server device 150 in step 1105. The server device 150 may determine a target product based on at least one of the distance, the residence time, the moving speed, and the moving direction. The server device 150 may determine a service to be provided to the terminal device 110 based on the determined target product (or product group) information, and transmit the service-related information to the terminal device 110. The service-related information may include coupon information related to a target product (or product group), additional discount information, interest-free purchase benefit information, bonus free gift information, and navigation information, and the like. The terminal device 110 may receive service-related information from the server device 150. Although not shown in drawings, the terminal device 110 may include an output unit, and the terminal device 110 may indicate service-related information which is received from the server device 150 through an output unit.

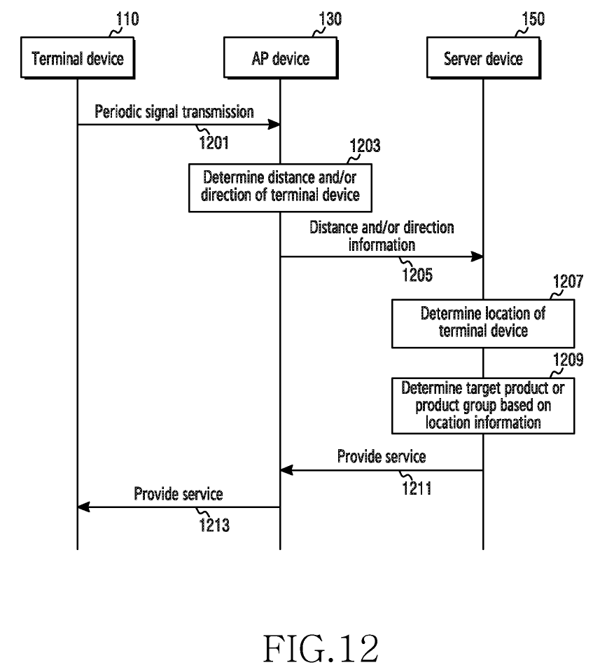

FIG. 12 is a signal flow diagram illustrating an example service based on the location information of a terminal device according to the present disclosure.

The terminal device 110, which has entered a store of a business operator, may periodically transmit a signal to the AP device in step 1201. For example, the terminal device 110 may be wirelessly connected to the specific AP device 130 (adjacent AP device) when entering the store of the business operator. In addition, as the terminal device 110 moves within the store, the terminal device 110 may perform handover between a plurality of AP devices installed in the store 110. As a result, the terminal device 110 may periodically transmit a signal to a specific AP device 130 in which a wireless communication connection is currently established.

The AP device 130 may determine at least one of the distance information and direction information of the terminal device 110 in step 1203. The AP device 130 indicates a device that is currently being connected to the terminal device 110 through wireless communication among a plurality of AP devices installed in the store. For example, the AP device 130 may periodically receive a signal from the terminal device, and may determine at least one of the distance and direction of the terminal device 110 using the received signal. For example, the AP device 130 may determine the distance between the terminal device 110 and the AP device 130 and the relative direction between the terminal device 110 and the AP device 130, respectively, using the strength of the signal (example RSSI) and the incident angle (e.g., AOA). The AP device 130 may periodically determine at least one of the distance and direction using the signal periodically received from the terminal device 110.

The AP device 130 may transmit at least one of the distance information and direction information to the server device 150 in step 1205. The AP device 130 and the server device 150 are capable of transmitting and receiving signals through a wired communication network. The AP device 130 may reflect a time flow into at least one of the determined distance information and direction information, and periodically transmit the same to the server device 150 through the wired communication network.

The server device 150 may determine the location of the terminal device 110 in step 1207. According to an example embodiment, the location of the terminal device 110, determined by the server device 150, may include a relative location based on the geographical structure of the store of the business operator. According to another example embodiment, the location of the terminal device 110, determined by the server device 150, may include an absolute location based on GPS. For example, the server device 150 may determine the location of the terminal device 110 based on at least one of location information of the specific AP device 130, stored in the memory, and the received distance information and direction information of the terminal device 110. For example, the server device 150 may know the location information (previously stored in the memory) of the specific AP device 130, and determine the location of the terminal device 110 based on the relative distance and relative direction between the specific AP device 130 and the terminal device 110. The server device 150 may periodically receive at least one of the distance information and direction information of the terminal device 110 from the specific AP device 130, and accordingly determine the location of the terminal device 110 over time. The server device 150 may cumulatively store, in the memory, location information of the terminal device 110 determined over time.

The server device 150 may determine a target product (or product group) based on the location information of the terminal device 110 in step 1209. According to an embodiment, the server device 150 may compare location information of the product (or product group) stored in the memory with the determined location information, so as to determine the distance between the terminal device 110 and the specific product (or product group). According to another example embodiment of the present disclosure, the server device 150 may analyze the location information of the terminal device 110 accumulated in the memory 110, so as to determine whether the terminal device 110 is staying for a predetermined time or more near a specific product (or a product group). For example, the server device 150 may determine a residence time during which the terminal device 110 stays in a position near the specific product (or product group). According to another example embodiment, the server device 150 may determine the moving speed of the terminal device 110 using the accumulated location information of the terminal device 110, and may determine whether the moving speed of the terminal device 110 near the specific product (or product group) is significantly reduced. According to another example embodiment, the server device 150 may determine the moving direction of the terminal device 110 using the accumulated location information of the terminal device 110, and may determine whether the terminal device 110 moves toward the specific product (or product group). As a result, the server device 150 may determine a target product (or product group), based on at least one of information on a distance, residence time, moving speed, moving direction of the terminal device 110.

The server device 150 may provide service-related information to the terminal device 110 in step 1211 and step 1213. For example, the server device 150 may determine a service to be provided to the terminal device 110 based on the determined target product (or product group) information, and transmit the service-related information to the terminal device 110 and/or through the AP device 130. The service-related information may include coupon information related to a target product (or product group), additional discount information, interest-free purchase benefit information, bonus free gift information, and navigation information, and the like.

FIG. 12 includes an embodiment in which the server device 150 receives the distance and direction information of the terminal device 110 from the AP device 130 to determine the location of the terminal device 110. However, in accordance with another example embodiment, the AP device 130 may determine the location information of the terminal device 110, and transmit the location information to the server device 150. In addition, the AP device 130 may determine at least one of the distance and direction of the terminal device 110 in FIG. 10, however, according to another example embodiment, the terminal device 110 may receive a signal from the AP device 130 and determine at least one of the distance and direction.

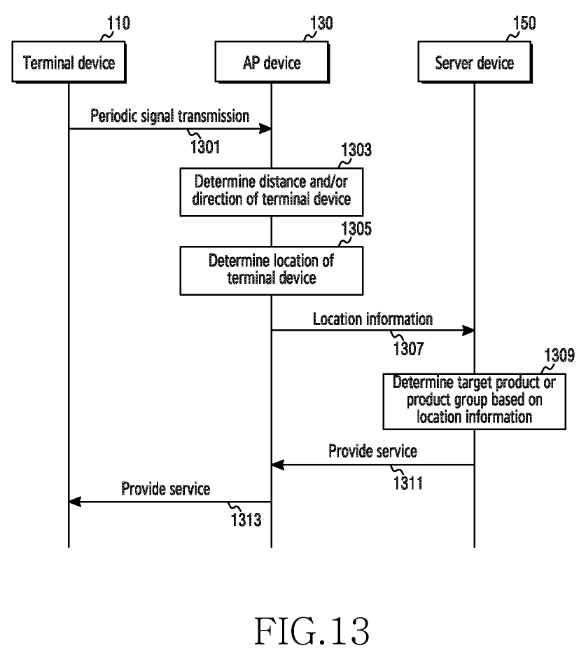

FIG. 13 is a signal flow diagram illustrating an example embodiment in which an AP device determines a location of a terminal device 110 according to the present disclosure.

Referring to FIG. 13, the AP device 130 may determine the distance and direction of the terminal device 1301 in steps 1301 and 1303. The detailed operations of the AP device 130 for the steps are the same as steps 1001 and 1003 of FIG. 10.

The AP device 130 may determine the location of the terminal device 110 in step 1305. The AP device 130 may determine the location of the terminal device 110 based on at least one of the location information of the AP device itself and the distance information and direction information of the terminal device 110. For example, the server device 130 may receive the location information of its own (or previously stored in the memory) from the server device 150, and determine the location of the terminal device 110 based on the relative distance and relative direction between the AP device 130 and the terminal device 110. The AP device 130 may periodically receive at least one of the distance information and direction information of the terminal device 110, and reflect a time flow into the received distance information and direction information, so as to periodically determine the location of the terminal device 110.

The AP device 130 may transmit the location information of the terminal device 110 to the server device 150 through a wired or wireless network in step 1307. The AP device 130 may periodically transmit the determined location information of the terminal device 110 to the server device 150.

Hereinafter, operations (steps 1309, 1311, and 1313) of determining the target product based on the location information and transmitting service-related information to the terminal device 110, by the service device 150 are the same as or similar to steps 1209, 1211, and 1213 of FIG. 12.

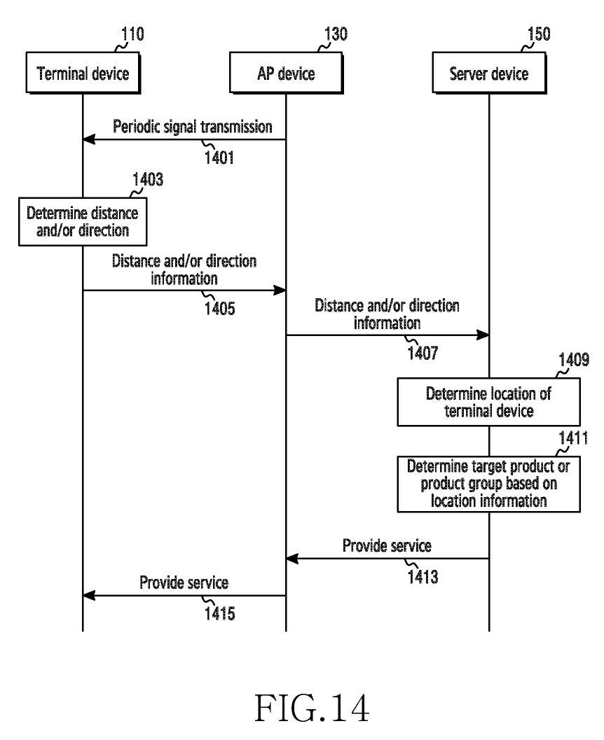

FIG. 14 is a flow diagram illustrating example signals related to an example embodiment in which the terminal device 110 determines at least one of the distance and direction according to the present disclosure.

Referring to FIG. 14, the terminal device 110 may receive a signal from the AP device 130 in step 1401. The terminal device 110 may periodically receive a signal. For example, the terminal device 110 may be wirelessly connected to the specific AP device 130 (adjacent AP device) when entering a store. The terminal device 110, wirelessly connected to the specific AP device 130, may periodically receive a wireless signal from the specific AP device 130. According to an example embodiment, the terminal device 110 may move within a store, and in this case, the terminal device 110 may be wirelessly connected to another AP device. For example, as the terminal device 110 moves in the store, the terminal device 110 may perform handover between a plurality of AP devices installed in the store. In this case, the terminal device 110 may periodically receive a wireless signal from an AP device that is currently being connected through wireless communication. The AP device that is currently being connected to the terminal device 110 through wireless communication may periodically transmit a wireless signal to the terminal device 110.

The terminal device 110 may determine at least one of the distance information and direction information of the terminal device 110 in step 1403. Specifically, the terminal device 110 may determine the distance between the terminal device 110 and the AP device 130 that is being connected through wireless communication, and the direction of the terminal device 110, using a signal received from the AP device 130. For example, the terminal device 110 may determine, using RSSI and AOA, the distance between the terminal device 110 and the AP device 130, and the relative direction between the terminal device 110 and the AP device 130, respectively.

The terminal device 110 may transmit at least one of the determined distance information and direction information to the AP device that is being currently connected through wireless communication, or the server device 150 through the AP device 130 in steps 1405 and 1407. The terminal device 110 may periodically determine at least one of the distance and direction, and periodically transmit the same to the AP device or the server device 150 through the AP device.

According to an example embodiment, the server device 150 may determine the location of the terminal device 110 in step 1409, and determine a target product (or product group) based on the determined location in step 1411. In addition, the server device 150 determines a service which can be provided relating to the determined target product (or product group), and transmits the service-related information to the terminal device 110 in steps 1413 and 1415. The detailed operation method of the server device 150 is the same as or similar to those presented in FIG. 10.

Although not shown in FIG. 14, according to another example embodiment, the AP device 130 may receive at least one of the distance information and direction information from the terminal device 110, and determine the location of the terminal device 110 based on at least one of the distance information and direction information. In addition, the AP device 130 may (periodically) transmit the determined location information of the terminal device 110 to the server device 150. The server device 150 may determine a target product (or product group) based on location information of the terminal device 110, and determine a service that can be provided. The server device 150 may transmit the determined service-related information to the terminal device 110. The detailed operation method of the server device 150 is the same as or similar to those presented in FIG. 11.

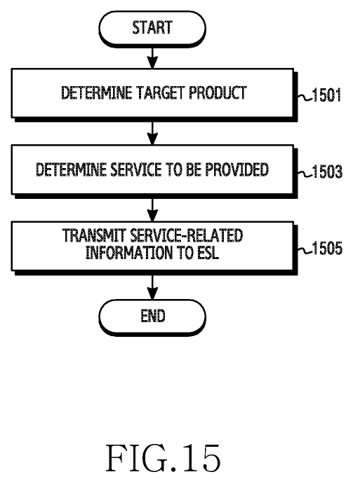

FIG. 15 is a flowchart illustrating an example method for providing service-related information through an ESL of a server device according to the present disclosure. An example operation method of the server device 150 is as follows.

The server device 150 may determine a target product in step 1501. According to an example embodiment, the server device 150 may receive the location information of the terminal device 110 determined in the AP device 130 from the AP device 130. The server device 150 may periodically receive location information of the terminal device 110 from the AP device 130 and cumulatively store the same in the memory. According to another example embodiment, the server device 150 may receive at least one of the distance information and direction information of the terminal device 110 from the AP device, and determine the location of the terminal device 110 using the same. The server device 150 may periodically receive at least one of the distance information and direction information of the terminal device 110 from the AP device 130, and periodically determine the location of the terminal device 110 so as to cumulatively store the location of the terminal device 110. The distance may indicate the relative distance between the terminal device 110 and the AP device 130, and may be determined through the RSSI. The direction may indicate the relative direction between the terminal device 110 and the AP device 110, and may be determined using the AOA according to an embodiment. The server device 150 may determine a target product (or product group) based on the determined location information of the terminal device 110. For example, the server device 150 may determine the distance between the terminal device 110 and a specific product (or product group), and the residence time, moving speed, and direction of the terminal device 110, by using the (accumulated) location information of the terminal device 110. The server device 150 may determine a target product (or product group), based on at least one of information on the determined distance, residence time, moving speed, and moving direction.

The server device 150 may determine a service to be provided, in step 1503. For example, the server device 150 may determine a service which can be provided and correspond to the determined target product (or product group). The service may include, for example, a coupon offering, an interest-free install service, a gift offering service, and the like.

The server device 150 may transmit service-related information to the ESL device 190 in step 1505. The ESL device 190 is a device for digitally displaying a product's name, price information, and the like. The ESL device 190 may include an output unit, and transmit the service-related information, received from the server device 150, to the terminal device 110 (e.g., the consumer) through the output unit.

FIG. 16 is a block diagram illustrating an example ESL device according to the present disclosure. The ESL device of FIG. 16 corresponds to the terminal device 190 of FIG. 1. Referring to FIG. 16, the ESL device 190 includes a communication unit (e.g., including communication circuitry) 1610, a storage unit 1630, a control unit (e.g., including control and/or processing circuitry) 1650, and an output unit (e.g., including output circuitry) 1670.

The communication unit 1610 may include various communication circuitry configured to perform functions for transmitting and receiving signals through a wireless channel. For example, the communication unit 1610 may perform a conversion function between a baseband signal and a bit string according to the physical layer specification of a system. For example, during data transmission, the communication unit 1610 may generate complex symbols by encoding and modulating transmission bit strings. In addition, upon receiving the data, the communication unit 1610 may reconstruct reception bit strings by demodulating and decoding the baseband signal. In addition, the communication unit 1610 may up-convert the baseband signal into a radio frequency (RF) band signal and then transmits the converted signal through the antenna, and down-converts an RF band signal received through the antenna into the baseband signal. For example, the communication unit 1610 may include various communication circuitry, such as, for example, and without limitation, a transmission filter, a reception filter, an amplifier, a mixer, an oscillator, a Digital to Analog Convertor (DAC), an Analog to Digital Convertor (ADC), or the like. In addition, the communication unit 160 may perform a wired communication function. The communication unit 1610 may transmit and receive information to and from the server device 150 through a wired/wireless communication function.

In addition, the communication unit 1610 may include different communication modules for processing signals of different frequency bands. For example, different communication standards may include Bluetooth low energy (BLE), Wi-Fi, Wi-Fi Gigabyte (WiGig), cellular networks (e.g., Long Term Evolution (LTE), etc. In addition, different frequency bands may include a super high frequency (SHF) (e.g., 2.5 GHz, 5 GHz) band and a millimeter wave (e.g., 60 GHz) band.

The communication unit 1610 transmits and receives signals as described above. Accordingly, the communication unit 1610 may be referred to as a transmission unit, a reception unit, or a transceiver or transceiver unit. In addition, the transmission and reception performed through the wireless channel in the description of the present disclosure are used to indicate that the processing as described above is performed by the communication unit 1610.

The storage unit 1630 stores data such as a basic program, an application program, and setting information, and the like for the operation of the ESL device 190. The storage unit 1630 may be configured as a volatile memory, a non-volatile memory, or a combination of a volatile memory and a non-volatile memory. The storage unit 1630 may store information on a product or a product group. In addition, the storage unit 1630 may store service-related information transmitted from the server. In addition, the storage unit 1630 provides the stored data to the output unit 1670 according to a request of the control unit 1650.

The control unit 1650 may include various control and/or processing circuitry configured to control overall operations of the ESL device 190. For example, the control unit 1650 controls transmission and reception of a signal through the communication unit 1610. In addition, the control unit 1650 records and reads data in and from the storage unit 1630. To this end, the control unit 1650 may include various processing and/or control circuitry, such as, for example, and without limitation, at least one processor or a microprocessor, or may be a part of a processor. In addition, a part of the communication unit 1610 and the control unit 1650 may be referred to as a Communication Processor (CP). The controller 1650 controls the ESL device 190 to display information related to a product or product group according to various embodiments described later. In addition, the control unit 1650 controls the ESL device 190 to display service information to be provided to a specific customer (terminal device).

The output unit 1670 may include various output circuitry that visually displays various pieces of information. The output unit 1670 may include, for example, a Liquid Crystal Display (LCD), a Light-Emitting Diode (LED) display, an Organic Light-Emitting Diode (OLED) display, a Micro Electro Mechanical Systems (MEMS) display, or an electronic paper display, or the like, but is not limited thereto. The output unit 1670 may display, for example, various types of contents (e.g., text, images, videos, icons, or symbols) to users. The output unit 1670 may include output circuitry, such as, for example, and without limitation, a touch screen, and may receive a touch, gesture, proximity, or hovering input using, for example, an electronic pen or the user's body part. In particular, the output unit 1670 may display information related to a product or product group according to various example embodiments described in greater detail below. In addition, the output unit 1670 may display service information to be provided to a specific customer (or terminal device).

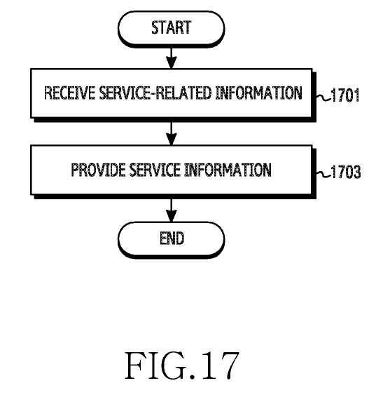

FIG. 17 is a flowchart illustrating an example method for providing service-related information by an ESL device according to the present disclosure. The ESL device corresponds to the ESL device 190 of FIG. 1. The ESL device 190 is a device for digitally displaying a product's name, price information, and service information, and the like. For example, the ESL device 190 may refer to a device for digitally displaying the product's name, price, logo, etc., by utilizing a low-power wireless communication technology and electronic paper display technology instead of displaying the same on paper using the existing method. The ESL device 190 may replace the price information, service information, etc., which are displayed in a large store, such as big retailers, in real time. In addition, an off-line store operator may directly respond to pricing, which is made by on-line distributors, using an ESL device 190, so that the issue of showrooming may be resolved.

The ESL device 190 may receive the service-related information in step 1701. For example, the ESL device 190 may be connected to the server device 150 through wired and wireless communication and receive the service-related information from the server device 150. The server device 150 may determine a target product (or a product group) and a service that can be provided, based on the (accumulated) location information of the terminal device 110, and transmit service-related information to the ESL device 190 as well as the terminal device 110.

The ESL device 190 may provide service information in step 1703. For example, the ESL device 190 may include an output unit. The output unit of the ESL device 190 includes various output circuitry, such as, for example, and without limitation, at least one of a speaker and a display. The ESL device 190 may transmit, to the terminal device 110 (e.g., a consumer), the service-related information received from the server device 150 through the output unit. The output unit of the ESL device 190 may transmit sound and image information related to the provided service to the user of the terminal device 110.

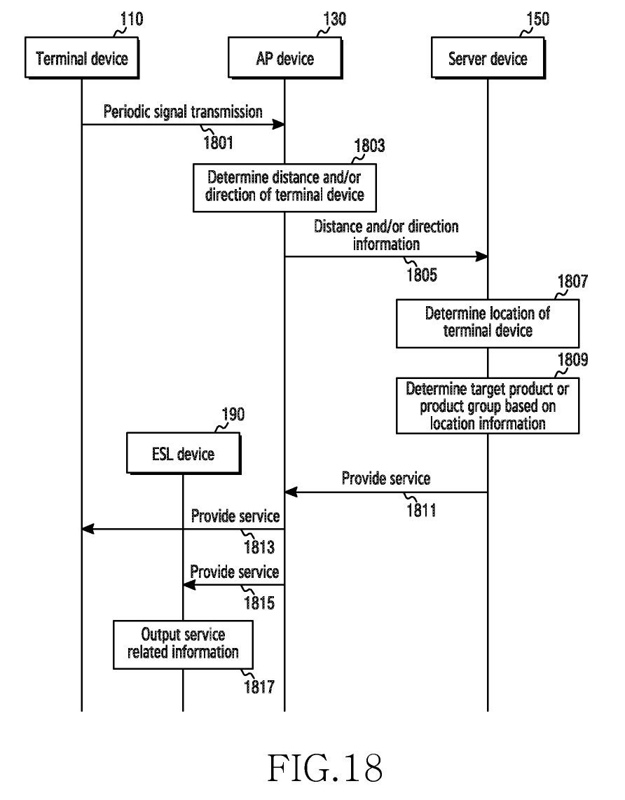

FIG. 18 is a signal flow illustrating an example of providing a service based on location information of a terminal device in a wired/wireless network structure including an ESL device according to the present disclosure.

The terminal device 110 which has entered a store of a business operator may periodically transmit a signal to the AP device, in step 1801. For example, the terminal device 110 may be wirelessly connected to the specific AP device 130 (adjacent AP device) when entering the store of the business operator. In addition, as the terminal device 110 moves within the store, the terminal device 110 may perform handover between a plurality of AP devices installed in the store 110. As a result, the terminal device 110 may periodically transmit a signal to a specific AP device 130 in which a wireless communication connection is currently established.

The AP device 130 may determine at least one of the distance information and direction information of the terminal device 110, in step 1803. The AP device 130 indicates a device that is currently establishing wireless communication with the terminal device 110 among a plurality of AP devices installed in the store. For example, the AP device 130 may periodically receive a signal from the terminal device, and determine at least one of the distance and direction of the terminal device 110 by using the received signal. For example, the AP device 130 may determine the distance between the terminal device 110 and the AP device 130 and the relative direction between the terminal device 110 and the AP device 130, respectively, using the intensity of the signal (e.g., RSSI) and the incident angle (e.g., AOA). The AP device 130 may periodically determine at least one of the distance and direction using the signal periodically received from the terminal device 110.

The AP device 130 may transmit at least one of the distance information and direction information to the server device 150 in step 1805. The AP device 130 and server device 150 are generally capable of transmitting and receiving signals through a wired communication network. The AP device 130 may reflect a time flow into at least one of the determined distance information and direction information, and periodically transmit the same to the server device 150 through the wired communication network.

The server device 150 may determine the location of the terminal device 110, in step 1807. According to an example embodiment, the location of the terminal device 110, determined by the server device 150, includes a relative location based on the geographical structure of the store of the business operator. According to another example embodiment, the location of the terminal device 110, determined by the server device 150, includes an absolute location based on GPS. For example, the server device 150 may determine the location of the terminal device 110 based on at least one of location information of the specific AP device 130, stored in the memory, and the received distance information and direction information of the terminal device 110. For example, the server device 150 may know the location information (previously stored in the memory) of the specific AP device 130, and determine the location of the terminal device 110 based on the relative distance and relative direction between the specific AP device 130 and the terminal device 110. The server device 150 may periodically receive at least one of the distance information and direction information of the terminal device 110 from the specific AP device 130, and accordingly determine the location of the terminal device 110 over time. The server device 150 may cumulatively store, in the memory, location information of the terminal device 110 determined over time.

The server device 150 may determine a target product (or product group) based on location information of the terminal device 110, in step 1809. According to an embodiment, the server device 150 may compare location information of a product (or product group) stored in the memory with the determined location information, so as to determine the distance between the terminal device 110 and the specific product (or product group). According to another example embodiment of the present disclosure, the server device 150 may analyze the location information of the terminal device 110 accumulated in the memory 110, so as to determine whether the terminal device 110 is staying for a predetermined time or more near a specific product (or a product group). That is, the server device 150 may determine a residence time during which the terminal device 110 stays in a position near the specific product (or product group). According to another example embodiment, the server device 150 may determine the moving speed of the terminal device 110 using the location information of the accumulated terminal device 110, and may determine whether the moving speed of the terminal device 110 near the specific product (or product group) is significantly reduced. According to another example embodiment, the server device 150 may determine the moving direction of the terminal device 110 using the accumulated location information of the terminal device 110, and may determine whether the terminal device 110 moves towards the specific product (or product group). As a result, the server device 150 may determine a target product (or product group), based on at least one of information on a distance, residence time, moving speed, moving direction of the terminal device 110.

The server device 150 may provide service-related information to the terminal device 110, in steps 1811 and 1813. For example, the server device 150 may determine a service to be provided to the terminal device 110 based on the determined target product (or product group) information, and transmit the service-related information to the terminal device 110. The service-related information may include coupon information related to a target product (or product group), additional discount information, interest-free purchase benefit information, bonus free gift information, and navigation information, and the like.

The AP device 130 may transmit the service-related information received from the server device 150 to the ESL device 190 in step 1815. The AP device 130 may transmit service-related information to the ESL device 190 through a wired or wireless communication method.

The ESL device 190 may output the service-related information in step 1817. The ESL device 190 may include an output unit including a speaker, a display and the like, and transmit service-related information to the terminal device 110 (that is, a user of the terminal device 110) through the output unit.

FIG. 18 includes an example embodiment in which the server device 150 receives the distance and direction information of the terminal device 110 from the AP device 130 to determine the location of the terminal device 110. However, in accordance with another example embodiment, the AP device 130 may determine location information of the terminal device 110, and transmit the location information to the server device 150. In addition, the AP device 130 may determine at least one of the distance and direction of the terminal device 110 in FIG. 10, however, according to another example embodiment, the terminal device 110 may receive a signal from the AP device 130 and determine at least one of the distance and direction.

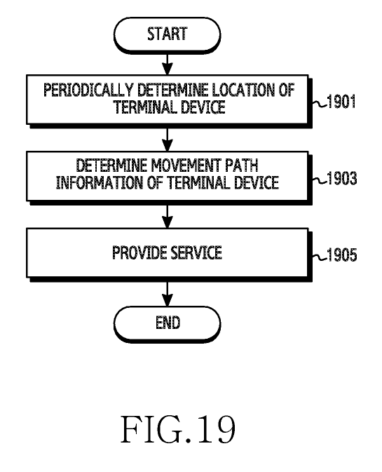

FIG. 19 is a flowchart illustrating an example method for providing a service through the determination of a movement path of a terminal device, by a server device, according to the present disclosure.

The server device 150 may periodically determine a location of the terminal device 110 in Step 1901. For example, the server device 150 may periodically determine a location of the terminal device 110 in Step 1901. According to an example embodiment, the server device 150 may receive at least one of the distance information and direction information of the terminal device 110 from the AP device 130. The server device 150 may periodically determine the location of the terminal device 110 on the basis of at least one of the received distance information and direction information of the terminal device 110 and cumulatively store the same in the memory. According to another example embodiment, the server device 150 may periodically receive location information of the terminal device 110 from the AP device 130, and cumulatively store the same in the memory.

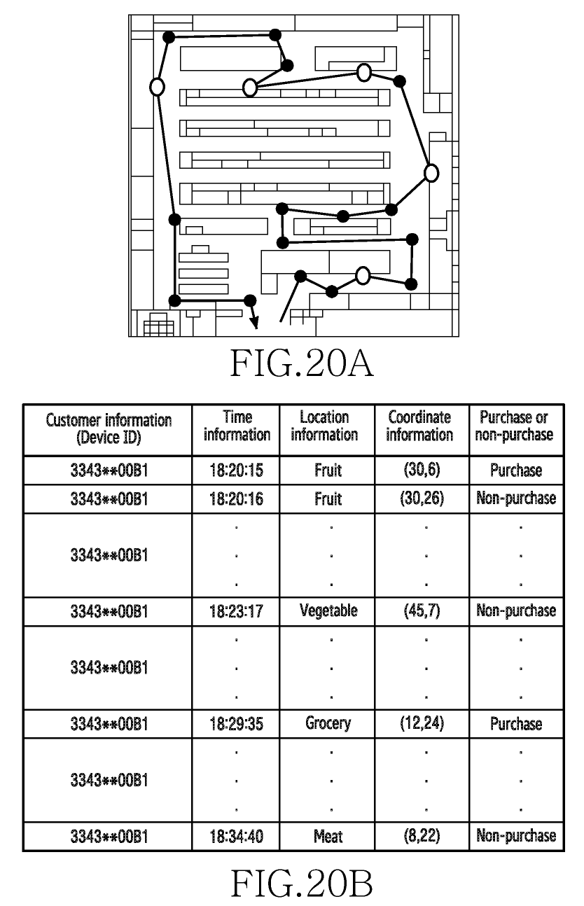

The server device 150 may determine movement path information of the terminal device 110 in step 1903. For example, the server device 150 may determine movement path information of the terminal device 110, using the location information of the terminal device 110, cumulatively stored in the memory while reflecting the time flow into the same. FIG. 20A illustrates example movement path information of the terminal device 110 according to an example embodiment. In FIG. 20A, each circle (white or black) indicates a product (or product group) determined as a target product (or product group) by the server device 150. For example, in FIG. 20A, a black circle indicates a position where a commercial user of the terminal device 110 has purchased a product, and a white circle indicates a position where the commercial user of the terminal device 110 has not purchased the product. FIG. 20B illustrates a target product or (product group) included in the movement path of the terminal device 110 according to an example embodiment. FIG. 20B indicates customer information, that is, location information over time of the terminal device corresponding to a device identifier 3343 ** 00B1, and product information (e.g., fruit, vegetables, food, meat, etc.) corresponding to the location. The server device 150 may analyze the location information of the terminal device over time, so as to determine movement path information of the terminal device, and determine whether to purchase a product included in the moving line. For example, the server device 150 may know whether to purchase a target product through a Point of Sales (POS) terminal according to an example embodiment. An operator of a store may install a POS terminal at a position in which a sales account is performed and manage sales information, and the like. Although FIG. 20A illustrates one piece of movement path information corresponding to the terminal device 110, a plurality of terminal devices may exist in the store, and the server device 150 may determine movement path information on each terminal device being moved in the store. In addition, the server device 150 may group and manage the movement path information of the terminal devices. Table 2 shows movement path information of four example terminal devices.

TABLE 2

| Deive ID | T1 | T2 | T3 |
|---|---|---|---|
| 3343**00B1 | (25, 27) | (28, 26) | (30, 6) |
| 2413*EA01 | (20, 30) | (18, 31) | (45, 7) |
| 5113*BD01 | (10, 20) | (8, 22) | (42, 18) |
| 2654*OA01 | (10, 30) | (12, 31) | (30, 24) |

Each of the terminal devices includes a device identifier (device ID, MAC address), and the server device 150 may know personal information corresponding to each terminal device through the device identifier. Personal information may include information on each terminal device user's age, sex, and occupation, and information on whether the user is a premium customer. The personal information may be provided to a store operator in the process of installing and registering an application by the terminal device user, and may be stored and managed in the server device 150. The server device 150 may group the movement path information on the basis of the movement path information of each terminal and personal information corresponding to each terminal device. For example, the server device 150 may group and manage movement path information of a man in his 30's. In another example, the server device 150 may group and manage the movement path information of a full time housewife. The server device 150 may extract movement path information so as to analyze an individual purchase tendency.

The server device 150 may provide a service in step 1905. The server device 150 may provide a service based on the movement path information of the terminal device 110 and the movement path information of the group to which the terminal device 110 belongs. For example, the server device 150 may provide a navigation function to the user of the terminal device 110 based on the movement path information of the terminal device 110. In other words, the server device 150 may store the movement path information of the terminal device 110 in the memory, and store a target product (or product group) information included in the movement path. When the location of the target product is changed in the future, the server device 150 may provide a navigation function to the direction of the target product changed through the application of the terminal device 110. In another example, the server device 150 may provide the navigation function according to a main movement path of the corresponding group based on the movement path information of the group to which the terminal device 110 belongs. In another example, the server device 150 may provide services, such as coupons, for products to be non-purchased based on the grouped movement path information.

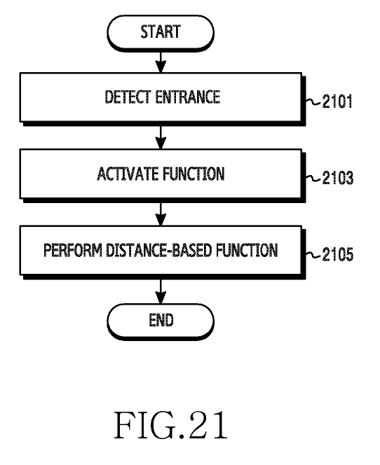

As described above, various example embodiments may enable services based on the location or movement path of the terminal device. The services according to various example embodiments described above may be provided when a certain function is activated in the terminal device. For example, an application designed to implement various embodiments may be required to be executed. According to an example embodiment, the application may be activated provided that it enters a particular location (e.g., store). In this case, an operation method for the terminal device is described in FIG. 21.

FIG. 21 is a flowchart illustrating an example method for operating a terminal device according to the present disclosure. The terminal device corresponds to the terminal device 110 of FIG. 1. The terminal device 110's user who uses the store may install an application operated by the store manager in the terminal device. In the process of application installation, the device identifier (device ID, MAC address) of the terminal device and personal information of the terminal device user (e.g., age, sex, occupation, etc.) may be provided to the store operator and stored in the server device 150.

The terminal device 110 may detect its entrance to the store in step 2101. When the terminal device 110 enters the entrance of a store, the terminal device 110 may detect its entrance to the store. For example, when the application installed in the terminal device 110 is activated as a background task and the terminal device 110 enters the store entrance, its entrance to the store may be detected by detecting a signal transmitted from the AP device 130. In another example, in a state where the application installed in the terminal device 110 is activated as a background task, the terminal device 110 may detect its entrance to the store using the location information of the store and the location information of the terminal device, previously stored in the terminal device. For example, the location information may be checked using the Global Positioning System (GPS).

The terminal device 110 may activate a function in step 2103. That is, the terminal device 110 may activate an application managed by the store operator as a foreground task. The terminal device 110 may execute an application.

The terminal device 110 may perform a distance-based function in step 2105. For example, the terminal device 110 may transmit and receive signals to and from the AP device 130, and may perform the distance-based function based on the transmitted and received signals. For example, the terminal device 110 may receive a signal from the AP device 130, and determine the distance and direction of the terminal device using the received signal. As another example, the terminal device 110 may be provided with a service from the server device according to the location information determined based on the distance and direction.

The methods described in the claims or the present disclosure can be implemented using hardware and software alone or in combination.

Any such software may be stored in a computer readable storage medium. The computer readable storage medium stores one or more programs (software modules) including instructions, which when executed by at least one processor in a device or apparatus, cause the device or apparatus to perform a method of the present disclosure.

Any such software may be stored in a non-transitory computer readable medium having, for example, the form of volatile or non-volatile storage such as Read Only Memory (ROM), or in the form of memory such as Random Access Memory (RAM), memory chips, device, or integrated circuits, or on an optically or magnetically readable medium such as a Compact Disc (CD)-ROM, Digital Versatile Disc (DVD), magnetic disk or magnetic tape or the like.

It will be appreciated that the storage devices and storage media are example embodiments of machine-readable storage that are suitable for storing a program or programs comprising instructions that, when executed, implement various example embodiments of the present disclosure. Accordingly, example embodiments provide a program comprising code for implementing apparatus or a method as claimed in any one of the claims of this disclosure and a machine-readable storage storing such a program. Still further, such programs may be conveyed electronically via any medium such as a communication signal carried over a wired or wireless connection and embodiments suitably encompass the same.

While the disclosure has been illustrated and described with reference to various example embodiments thereof, it will be understood by those skilled in the art that various changes in form and details may be made therein without departing from the spirit and scope of the disclosure as defined by the appended claims and their equivalents.

What is claimed is:

1. A server device for determining a product of interest using a terminal device, the server device comprising:
at least one transceiver configured to receive at least one of distance information and direction information of a terminal device; and
at least one processor configured to:
determine a location of the terminal device based on at least one of the distance information and the direction information, and
determine a target product based on the location of the terminal device.

2. The server device of claim 1, wherein the at least one processor is further configured to
determine at least one of: a moving speed, a residence time, and a moving direction of the terminal device, and determining a distance between the terminal device and at least one product based on the location of the terminal device; and
determine the target product based on at least one of the moving speed, residence time, and moving direction of the terminal device, and the distance between the terminal device and at least one product.

3. The server device of claim 1, further comprising transmitting information related to the target product to at least one of the terminal device and an electronic shelf label (ESL) device.

4. The server device of claim 3, wherein the at least one processor is further configured to determine movement path information of the terminal device based on the location information, and
wherein the transceiver is further configured to transmit information related to the target product to the terminal device based on the movement path information.

5. The server device of claim 3, wherein the information related to the target product includes navigation service information for the terminal device.

6. The server device of claim 4, wherein the at least one processor is further configured to group the movement path information of the terminal device, and
wherein the at least one transceiver is further configured to transmit the information related to the target product based on the grouped movement path information.

7. The server device of claim 1, wherein the at least one transceiver is further configured to periodically receive at least one of the distance information and the direction information, and
wherein the at least one processor is further configured to periodically determine the location of the terminal device based on at least one of the periodically received distance information and direction information.

8. A terminal device comprising:
transmitting and/or receiving a signal to and/or from an access point (AP) device through a wireless communication connection; and
receiving, from a server device, information related to a target product determined based on the signal,
wherein the signal is used to determine the location of the terminal device, and the target product is determined based on the location of the terminal device.

9. The terminal device of claim 8, further comprising:
determining at least one of distance information and direction information of the terminal device based on the signal; and
transmitting, to the server device, at least one of the distance information and the direction information, wherein the location of the terminal device is based on at least one of the distance information and the direction information.

10. The terminal device of claim 8, wherein the target product is determined based on at least one of a moving speed, a residence time, and a moving direction of the terminal device, and a distance between the terminal and at least one product, the moving speed, residence time, moving direction and distance are determined based on the location of the terminal device.

11. The terminal device of claim 8, further comprising detecting an entrance of the terminal device into a store based on one of:
location information of the store, and
execution of an application of the terminal device.

12. An electronic shelf label (ESL) device, comprising:
receiving information related to a target product; and
transmitting information related to the target product to a terminal device through an output unit,
wherein the target product is determined based on location information of the terminal.

13. The ESL device of claim 12, wherein transmitting of the information related to the target product to the terminal device comprises transmitting information related to the target product to the terminal device using at least one of sound information and image information.

14. The ESL device of claim 12, wherein the target product is determined based on at least one of a moving speed, residence time, and moving direction of the terminal device, and a distance between the terminal device and at least one product, the moving speed, residence time, moving direction and distance being determined based on a location of the terminal device.

15. A method of determining, by a server device, a product of interest, using a terminal device, the method comprising:
receiving at least one of distance information and direction information of a terminal device;
determining a location of the terminal device based on at least one of the distance information and the direction information; and
determining a target product based on the location of the terminal device.

16. The method of claim 15, further comprising determining at least one of: a moving speed, a residence time, and a moving direction of the terminal device, and determining a distance between the terminal device and at least one product based on the location of the terminal device, and
wherein the determining of the target product comprises determining the target product based on at least one of the moving speed, residence time, and moving direction of the terminal device, and the distance between the terminal device and at least one product.

17. The method of claim 15, further comprising transmitting information related to the target product to at least one of the terminal device and an electronic shelf label (ESL) device.

18. The method of claim 17, further comprising determining movement path information of the terminal device based on the location information, and
wherein the transmitting of the information related to the target device comprises transmitting the information related to the target product to the terminal device based on the movement path information.

19. The method of claim 18, further comprising grouping the movement path information of the terminal device, and
wherein the transmitting of the information related to the target product comprises transmitting information related to the target product based on the grouped movement path information.

20. The method of claim 15, wherein receiving the at least one of the distance information and direction information of the terminal device comprises periodically receiving the at least one of the distance information and the direction information, and
wherein the determining of the location of the terminal device comprises periodically determining the location of the terminal device based on at least one of the periodically received distance information and direction information.
